(19) United States
(12) Patent Application Publication
(10) Pub. No.: US 2013/0340065 A1
(43) Pub. Date: Dec. 19, 2013

(54) OFFLINE AND ONLINE PLATFORM FOR SOCIAL NETWORKING VIA A PROXY

(71) Applicant: ProxyPeople, Inc., Portland, OR (US)

(72) Inventor: David Dyer, Portland, OR (US)

(21) Appl. No.: 13/918,694

(22) Filed: Jun. 14, 2013

Related U.S. Application Data
(60) Provisional application No. 61/660,418, filed on Jun. 15, 2012.

(51) Int. Cl. H04L 29/06

(52) U.S. Cl. CPC H04L 63/0281
USPC 726/12

(57) ABSTRACT

The present solution may be implemented to provide a connectivity platform where children are provided the power of connectivity they seek in a safe, fun and simple online and offline form that children and parents can both embrace. In one implementation, the disclosure provides children a toy, game, application, and online platform under a single overarching platform. This platform connects online and offline interaction by letting children discover people, places and things in the real world and track them online. The platform provides children with a game for collecting friends, while providing parents a way to monitor the activity of their children. At the same time, the platform provides parents, teachers, and brand partners the ability to incentivize children and teach social responsibility, thereby providing a learning experience that existing social networks do not and cannot provide.

### RELATED APPLICATION

This application claims the benefit of and priority to U.S. Provisional Application No. 61/660,418, entitled “Offline And Online Platform For Social Networking Via A Proxy”, and filed on Jun. 15, 2012, which is incorporated herein by reference in its entirety for all purposes.

### DESCRIPTION OF THE RELATED TECHNOLOGY

Existing social networks are not designed for children. In fact, many social networks require that users be over the age of thirteen. Even then, millions of children under the age of 13 continue to use such social networks. Incidences of bullying, inappropriate activities involving online predators and other harmful behavior have increased in social networks and have put the children who use these existing social networks at risk.

### SUMMARY

The systems, methods and devices of the disclosure each have several innovative aspects directed towards an online platform and proxy device for providing safer social networking for children.

Innovative aspects of the subject matter described in this disclosure can be implemented to provide a connectivity platform where children are provided the power of connectivity they seek in a safe, fun and simple online and offline form that children and parents can both embrace. In one implementation, the disclosure provides children a toy, game, application, and online platform under a single overarching platform. This platform connects online and offline interaction by letting children discover people, places and things in the real world and track them online. The platform provides children with a game for collecting friends, while providing parents a way to monitor the activity of their children. At the same time, the platform provides parents, teachers, and brand partners the ability to incentivize children and teach social responsibility, thereby providing a learning experience that existing social networks do not and cannot provide.

The platform allows users such as children to participate in events, challenges and promotions by checking into physical locations. Users track who and when they meet and collect virtual points, skills, and goods from other participants of the platform. These participants can be connected to products, promotions, locations or people.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example block diagram of an environment where a proxy device associated with a child can interact with people, places and things in an offline and online world.

FIG. 2 shows an example block diagram of a proxy device associated with FIG. 1.

FIG. 3 shows an example block diagram of a portal associated with FIG. 1.

FIG. 4 shows an example pictorial representation of two proxy devices configured to engage in the environment of FIG. 1.

FIG. 5 shows an example implementation of a proxy device.

FIG. 6 shows an example screenshot of one type of user interface of the portal associated with FIG. 3.

FIG. 7 shows example mobile application screenshots of a user interface of the portal associated with FIG. 3.

FIG. 8 shows an example tablet application screenshot of a user interface of the portal associated with FIG. 3.

FIG. 9 shows an example flow chart of a process corresponding to the environment of FIG. 1.

FIG. 10 shows example cross-sectional views of a proxy device including a USB drive and detachable cover portion.

### DETAILED DESCRIPTION

This disclosure describes systems, methods and devices for providing a social networking and gaming platform with a corresponding proxy device via which children are provided the power of connectivity they seek in a safe and fun online and offline form. In particular, the platform provides children the ability to interact with the real world via a proxy device and track and store these real world interactions onto the online social networking platform.

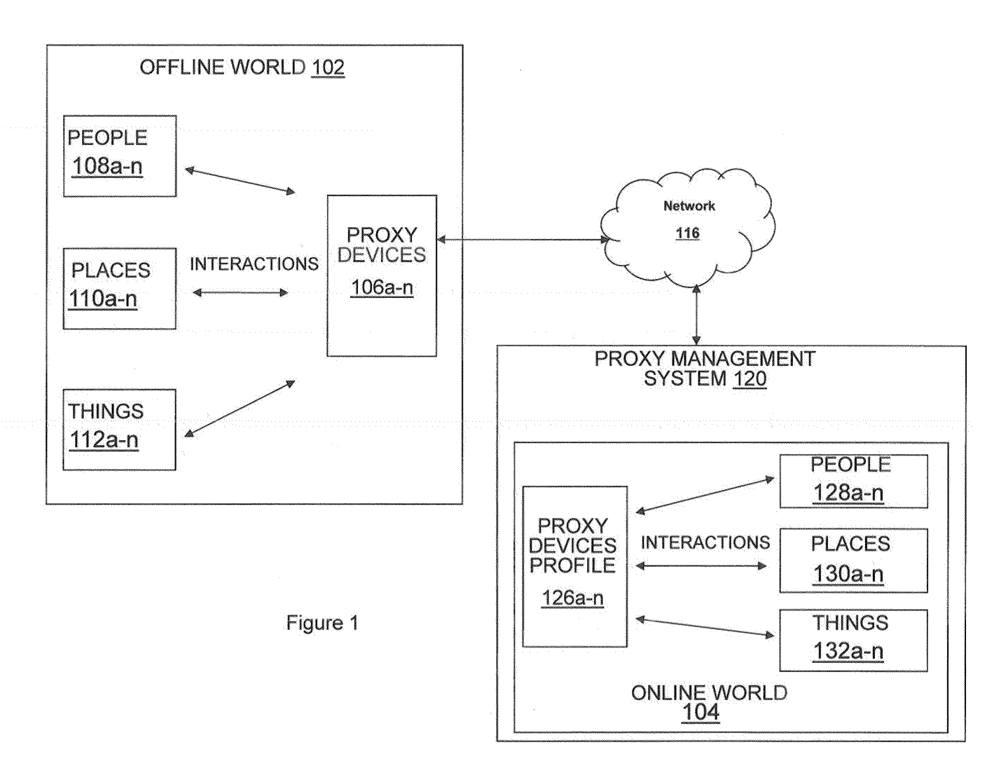

FIG. 1 shows an example block diagram of an environment via which a proxy device can interact with people, places and things in an offline and online world. In particular, the environment 100 includes an offline world environment 102 and an online world environment 104 that corresponds to and/or tracks the user's interactions with the offline world environment 102, such via a proxy device. The user interacts in or with the offline world environment 102 via a plurality of proxy devices 106a-n (generally “proxy device 106”) that are designed and constructed to enable and manage interactions of the proxy device 106 with people 108a-n, places 110a-n, and things 112a-n, such via other proxy devices, bar codes, QR codes, quick codes and equipment designed and constructed to communicate with the proxy devices, such as via RFID or NFC communications. A proxy device 106 is a portable or mobile device that is configured to connect with other proxy devices associated with people 108a-n or with equipment associated with places 110a-n or things 112a-n that are equipped to connect with the proxy device 106. In this way, the proxy device 106 allows a user to develop associations with people, places and things through real-world interactions that take place between the proxy device and equipment associated with such people, places and things. The proxy device 106 has an online identity created by the user that can be shared with the people, places, and things that the proxy device interacts with in the offline world environment. In this way, the user, via the proxy device, is able to make interactions without revealing the identity of the user. The proxy device 106 manages these real-world interactions that take place in the offline world 102 and uploads them to the online world environment 104, where the user associated with the proxy device can enhance those interactions, while maintaining the anonymity of the user's identity. The proxy device 106 manages these interactions by recording information pertaining to communications or connections made with equipment associated with people, places and things, including identifying information of the equipment, the time and type of connection/communication, as well as information transferred during the connection/communication.

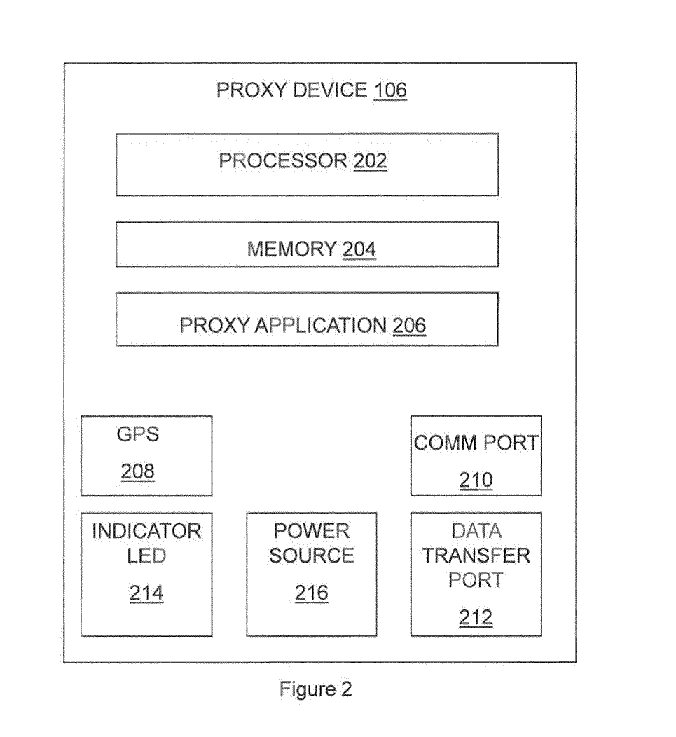

Examples of interactions that occur in the offline world include meeting people via their associated proxy devices, visiting places, such as restaurants, shops, grocery stores, malls, parks, stadiums, or other venues or establishments that are equipped to interact with the proxy device 106. In some implementations, these interactions with places may include taking part in an activity, such as a park cleanup, tagging grocery items in a grocery store, or reading a book at a bookstore. The proxy device 106 may also interact with things 112a-n, such as monuments, retail items, advertisements, vehicles, or any thing that is equipped to interact with the proxy device 106. Additional details regarding the proxy device are provided below with respect to FIG. 2.

People 108a-n (or in singular, person 108a) can interact with the proxy device 106 via a proxy device of their own. In this way, the user of the proxy device 106 can establish an interaction with a person 108a by allowing the proxy device 106 to connect with the proxy device associated with the person 108a. In this way, the proxy devices 106 can share their identities with one another, thereby avoiding the need to share information corresponding to the users of the proxy devices. These proxy devices can connect with one another and exchange information. In some embodiments, people can interact with the proxy device via a smart phone or mobile devices that has a communications module compatible with the proxy device.

Places 110a-n can interact with the proxy device 106 via equipment corresponding to the particular place. The equipment is configured to connect to the proxy device 106 such that the proxy device 106 and the equipment can share information. For example, if the place is a bookstore, equipment at the bookstore can connect with the proxy device and share identifying information of the bookstore. The proxy device can use this information and record information pertaining to the connection with the equipment at the bookstore to manage the interaction.

Things 112a-n can also interact with the proxy device 106 via equipment corresponding to the particular thing. The equipment is configured to connect to the proxy device 106 such that the proxy device 106 and the equipment can share information. For example, if the thing is a monument, equipment corresponding to the monument can connect with the proxy device and share identifying information of the monument. The proxy device can use this information and record information pertaining to the monument and the connection with the equipment to manage the interaction.

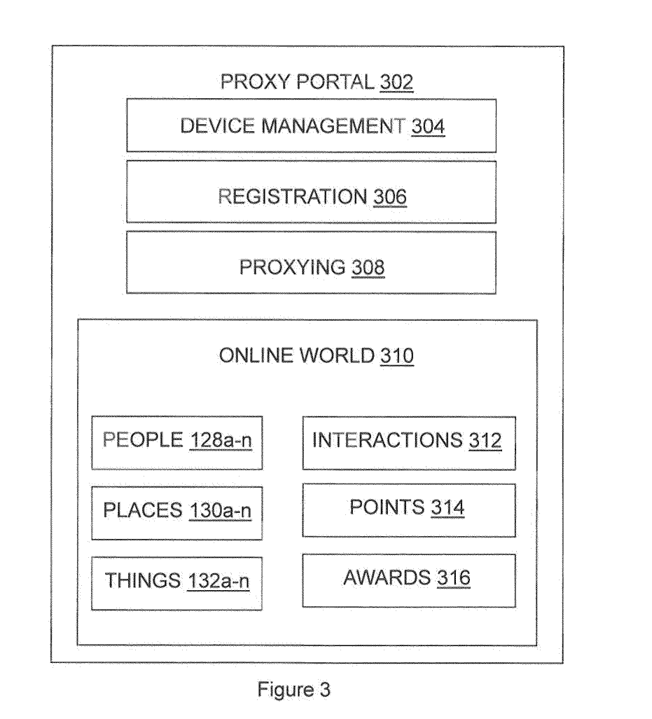

The proxy device 106 can communicate with a proxy management system 120 over a network 116. In this way, the proxy device 106 can upload information corresponding to the interactions between the proxy device 106 and people, places and things to the online world environment 104. The proxy management system 120 may include a processor, a memory, and other computer elements through which the proxy management system 120 can provide users an online platform that includes objects corresponding to the offline world. Specifically, proxy devices 106 have associated proxy device objects 126a-n (generally proxy device object 126) and the people 108a-n, places 110a-n, and things 112a-n have corresponding people objects 128a-n, places objects 130a-n, and things objects 132a-n, (generally PPT objects 128-132) respectively. These objects may be computer-based structures, such as data structure or constructs, through which users associated with the proxy devices can interact online. In some implementations, the proxy device objects 126 can be social network profiles that correspond to the proxy device. Additional details related to the proxy device objects is provided with respect to FIG. 3. Similar to the offline world environment 102, the proxy device object 126 can also interact with the PPT objects 128-132. These interactions may enhance the interactions made in the offline world environment 102 or may be new interactions that are established in the online world 104. Additional details regarding these interactions will be described below with respect to FIG. 3.

FIG. 2 shows an example block diagram of a proxy device associated with FIG. 1. The proxy device 106 includes a processor 202, a memory 204 and a proxy application 206 that may include computer-readable instructions stored on memory, which when executed by the processor 202, may cause the proxy device 106 to perform the functionality described herein.

The proxy device 106 may also include a global positioning system 208 (“GPS” 208) for determining the location of the proxy device 106, a communication port 210 through which the proxy device 106 can communicate with equipment of people 108a-n, places 110a-n and things 112a-n. The communication port may include, implement or support any type and form of communications and protocols, such as an short range communications of NFC, RFID or Bluetooth. In some implementations, the communication port 210 can be an RFID port for communicating using radio frequency technology. For example, the proxy device 106 can use Near Field Communication (“NFC”) to communicate wirelessly with other equipment. NFC is a set of short-range wireless technologies, typically requiring a distance of 4 cm or less. NFC involves an initiator and a target; the initiator actively generates an RF field that can power a passive target. This enables NFC targets to have simple form factors such as tags, stickers, key fobs, or cards that do not require batteries. NFC tags can securely store data. In some implementations, equipment corresponding to places 110a-n and things 112a-n may be NFC targets that are configured to communicate with the proxy devices 106. In some embodiments, the communications port comprises wireless technology, including cellular and/or wi-fi technology for communications.

The proxy device 106 may also include a data transfer port 212 that is configured to transfer data from the proxy device 106 to the proxy management system 120. The data transfer port 212 may include a USB port or connector, a wireless communications port, such as a WiFi antenna, a RFID port, or a cellular communication port. In some implementations, the proxy device 106 may connect to a host computing device, such as a laptop or desktop, which communicates with the proxy management system 120 via the network 116.

The proxy device 106 also includes an indicator light source 214 configured to output light notifications, such as to notify a user of the proxy device 106. In some implementations, the indicator light source 214 includes one or more LEDs of one or more colors. The indicator light source 214 may output light of different colors and intensities based on the activity being performed. For instance, a green light may appear when a connection has been established. A red light may appear when the connection is terminated. Another light or color may be use to indicate the transfer of date between the proxy device and another device. In addition, other notifications indicating low available memory space or low power may be represented using the same or different color light sources 214. In some implementations, the indicator light source 214 may emit light of different colors based on the number of points or social game status associated with the proxy device.

The proxy device 106 also includes a power source 216 configured to power one or more of the components of the proxy device 106, including the processor 202, the GPS 208, the communication port 210, the data transfer port 212, and the indicator light 214. The power source may be a battery that is rechargeable. In some implementations, the data transfer port 212 is a USB port, which when connected to a computing device, is configured to receive electrical power through which the power source 216 is charged.

The proxy device may be used as a payment method. As described above, the proxy device can communicate with equipment using one or more methods of communication. Accordingly, in some implementations, the equipment with which the proxy device is configured can communicate with the proxy device in such a manner as to receive payments, thereby allowing the proxy device to serve as a payment solution and may also allow children to establish a money saving account, such as a piggy bank. For example, the proxy device may use NFC communications to make payment to a payment receiving and processing system that receives and/or accept payment via NFC.

FIG. 3 shows an example block diagram of a proxy portal 302 associated with the proxy management system 120 of FIG. 1. The proxy portal 302 is configured to provide users an interface through which the users can participate in interactions online. The proxy portal 302 includes a device management module 304 that is configured to manage one or more proxy devices 106. The device management module can manage various functionality of the proxy device, including receiving data from and transmitting data to the proxy device. In addition, the device management module can provide firmware updates to the proxy device as well as reconfigure settings associated with the proxy device.

The proxy portal may also include a registration module 306 that is configured to manage the registrations of the proxy devices 106. In some implementations, the proxy device needs to be registered with the proxy management system prior to activation for use. The registration module is configured to handle the registration process. The registration module may be configured to maintain a database that links a proxy device 106 to registration information provided by a user associated with the proxy device 106.

The proxy portal 302 may also include a proxying module 308 that is configured to manage the relationship between the user and the proxy device 106. This includes maintain the user's anonymity, while the user engages with the proxy portal 302 via the user's proxy device 106. As such, as the proxy device 106 interacts in the offline world environment 102 and those interactions are enhanced in the online word environment 104, the proxying module 308 maintains the user's anonymity. This includes creating and managing an online profile for the proxy device. In some implementations, the proxying module 308 also monitors security risks and threats to the user or the user's identity. In this way and in some embodiments, the data is associated with a proxy device instead of to a user. Accordingly, the proxy device and proxy portal 302 provides a layer of abstraction to protect the user while providing a way to interact with both the offline world environment 102 and online world environment 104 without disclosing the user's identity.

The proxy portal may also include an online world module 310 that is configured to provide users associated with the proxy devices an online platform through which the users can monitor the activity and interactions of their proxy device as well as of other proxy devices. In addition, the online world module 310 may provide users a platform through which the users can enhance their interactions in the offline world environment. In particular, the online world module 310 can receive information from the proxy devices and present the received information to users on the online platform. The information received from the proxy devices include information pertaining to interactions with people, places, and things. In some embodiments, the online world module 310 may include objects associated with people, places, and things. These objects may store information pertaining to the proxy devices and their users, places, and things that can be used by the online world module. The online world module 310 may also include objects associated with interactions 312, points 314, and rewards 316.

The online world module 302 may provide an online world environment 102 where users may share and enhance interactions previously made in the offline world environment 102 or make new interactions in the online world environment 102. The online world environment may be implemented on one or more servers that can host a website, web pages, a social network, amongst others. The online world environment 102 can be implemented to provide a connectivity platform where children are provided the power of connectivity they seek in a safe, fun and simple online and offline form that children and parents can both embrace. This platform connects online and offline interaction by letting children discover people, places and things in the real world and track them online. The platform provides children with a game for collecting friends, while providing parents a way to monitor the activity of their children. At the same time, the platform provides parents, teachers, and brand partners the ability to incentivize children and teach social responsibility, thereby providing a learning experience that existing social networks do not and cannot provide.

Specifically, the proxy portal 302 allows information acquired by the proxy device to be uploaded, transmitted to or provided to the online world environment. This information includes interactions made between the proxy device and different people, places and things. The interactions may include a date and time of interaction, the location of the interaction (such as via GPS information), and the type of interaction, such as a data transfer, a file transfer, and the like.

The proxy portal can use the received information to create a social timeline for the interactions of a user. In addition, the proxy portal can also group proxy devices that have similar activities or interactions together based on their interactions in the offline world environment 102 and their online world environment 104. As a result, the proxy devices develop associations with other people, places and things based on the interactions of the proxy device instead of the user of the proxy device. Using GPS information, the proxy portal can identify and track the geo-location of the proxy device and where and when the proxy device interacted with the offline world and a timeline of the same (e.g., interacted with a second proxy device at a first location at a first time, interacted with a place or thing as a second location at a second time, traveled from first location to second location without interactions, etc.)

In some implementations, the proxy portal 302 may provide a game layer where users can receive points or virtual skills and objects for certain interactions or activities. In this way, users can acquire points for participating in such interactions or activities, and then use those points to earn rewards. For example, points can be awarded to a user for making an introduction with another proxy device, for visiting a particular place, such as a bookstore or library, or for finding a particular thing, such as a can of beans, in a grocery store. These are examples of interactions with people, places, or things. In addition, interactions may involve some type of activity for which points may also be awarded to a user. Examples of such activities include cleaning up a park, reading a book, attending a charity event, and the like. Such activities can be monitored and tracked via interactions of the proxy device. For instance, if a child helps clean a park, the child may be required to make an interaction with equipment associated with the activity using the proxy device. In this way, the proxy device can track each and every interaction with people, places, and things, as well as track any activities that involve people, places, and things.

In addition, the proxy device may earn points based on the online activity of the associated user. The user may acquire or earn points or virtual goods by sharing information about their interactions, completing surveys, and participating in other online activities. These points may be redeemed for prizes. Prizes may include toys for the user of the proxy device or virtual prizes to be used in the online game. In some implementations, the points may be applied to charitable or social causes thereby promoting social responsibility. For instance, the points can be redeemed to provide a mosquito net to a family in Africa or to provide a meal to the homeless.

In addition, the proxy portal 302 may also provide awards to proxy devices for certain interactions or activities. For instance, the proxy device may be provided an award of “Best citizen” for earning the most points that are associated with citizenry. Similarly, the proxy device can earn an award for earning the most points that are associated with reading. In some implementations, the proxy device can earn awards for redeeming their points in a socially responsible manner. This further promotes social responsibility.

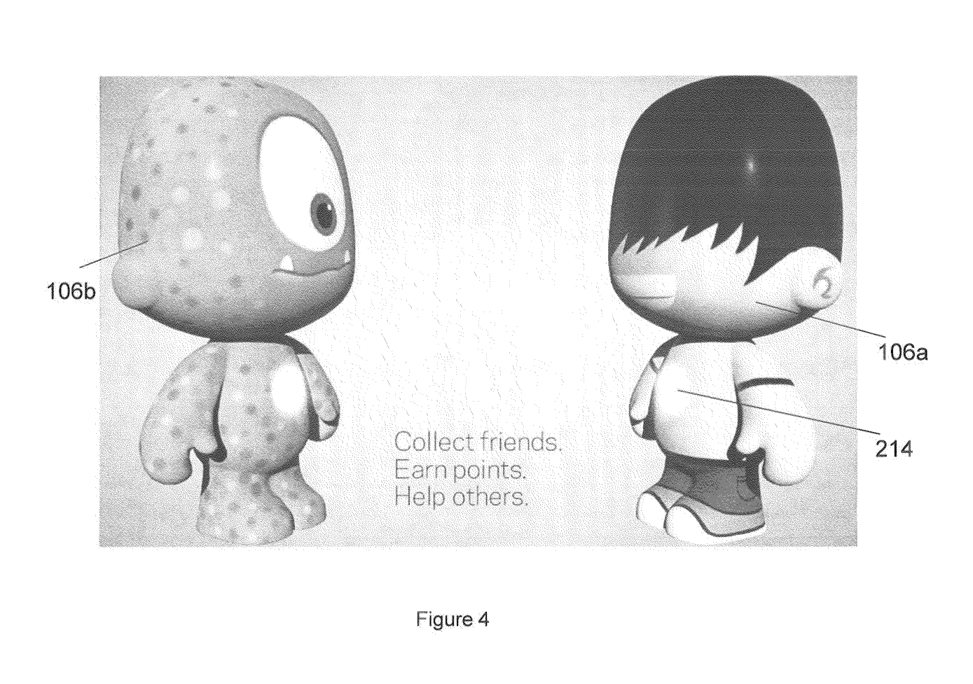

FIG. 4 shows an example pictorial representation of two proxy devices configured to engage in the environment of FIG. 1. A first proxy device 106A may interact with a second proxy device 106B using wireless communication methods. For example, the first proxy device 106A may connect with the second proxy device 106B using NFC. Once a connection is made, information identifying the proxy devices are exchanged and stored in their local memories. The information is then uploaded to the proxy portal 302, where the online profile of the proxy devices are updated to include the interaction. The proxy devices can be registered with and/or friends on the proxy portal and points can be awarded to both devices for the interaction. In some implementations, the proxy device 106a may include an LED 214 that provides an indication when a connection is made and data is being transferred. The LED 214 can emit light of varying colors and intensities to provide different notice or information to the users of the proxy devices.

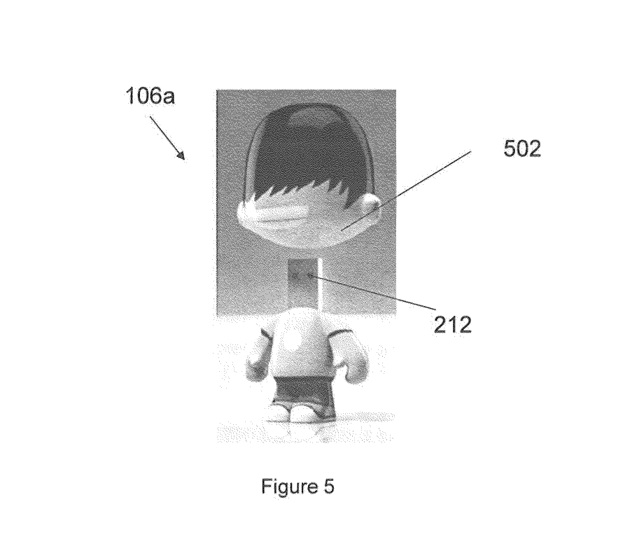

FIG. 5 shows an example implementation of the proxy device 106a. The proxy device can include a detachable portion 502 that exposes a data transfer port 212, such as a USB port. In some implementations, the proxy device 106a can include an actuation mechanism that allows the USB port to be exposed without having to detach a portion of the proxy device. In some implementations, the proxy device 106a may include a wireless data transfer port, eliminating the need of a detachable portion or an actuation mechanism to expose the data transfer port 212.

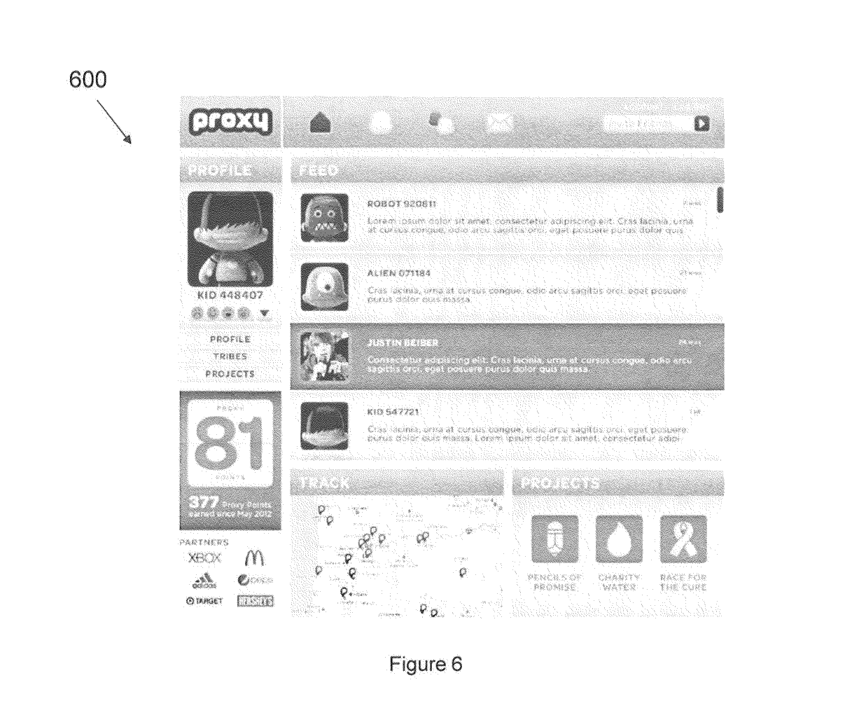

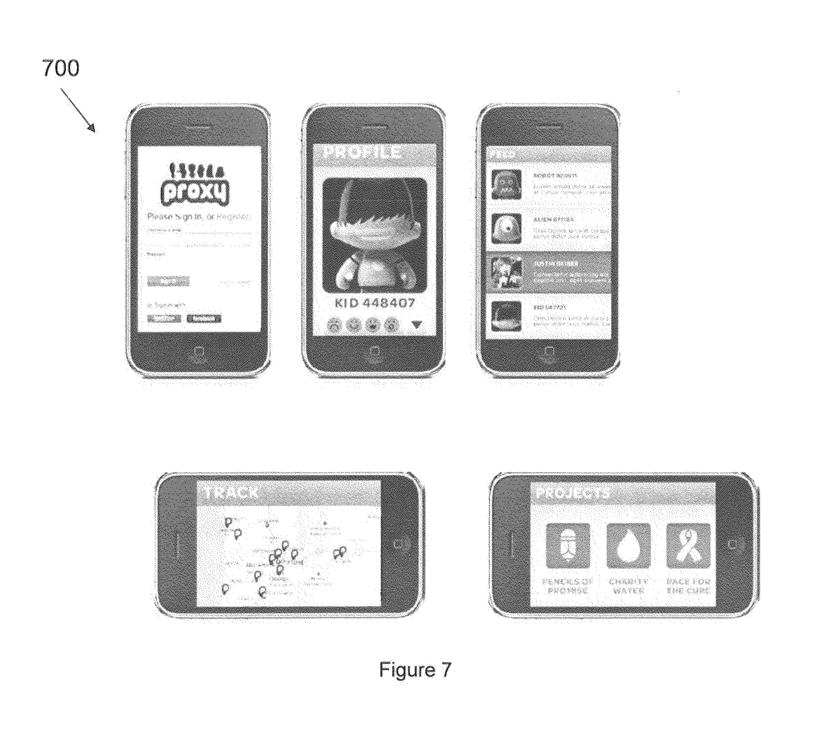

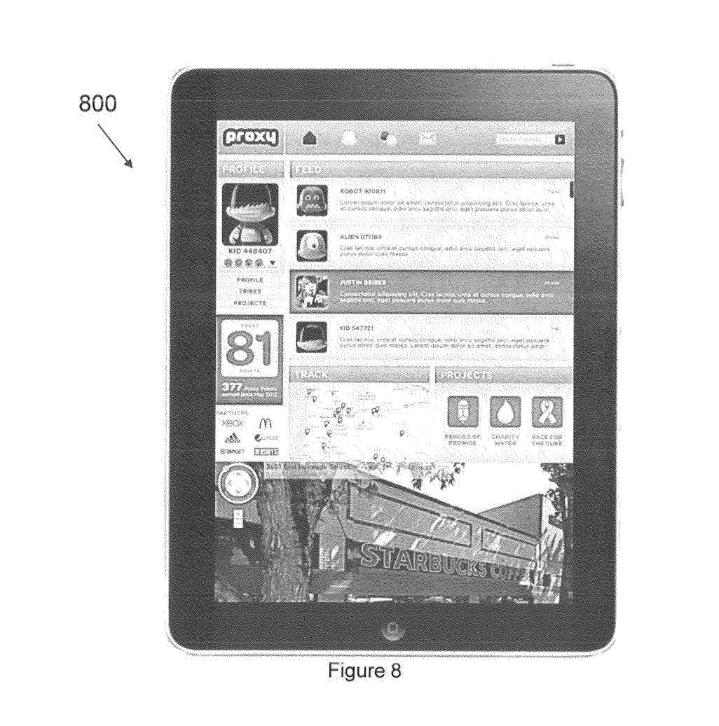

FIG. 6 shows an example screenshot 600 of a user interface of the portal associated with FIG. 3. As shown, the screenshot includes profile information of the proxy device, a feed corresponding to activity associated with people, places and things associated with the proxy device, a map indicating places where the proxy device has had interactions, social projects that the proxy device is supporting, and a points chart indicating the number of points the proxy device has earned. From the screenshot, it is clear that the profile relates to the proxy device and not to the user associated with the proxy device. In this way, a user of the proxy device can maintain his or her anonymity while discovering new people, places and things online. FIG. 7 shows example mobile application screenshots 700 of a user interface of the portal 302 and FIG. 8 shows an example tablet application screenshot of a user interface of the portal 302 associated with FIG. 3.

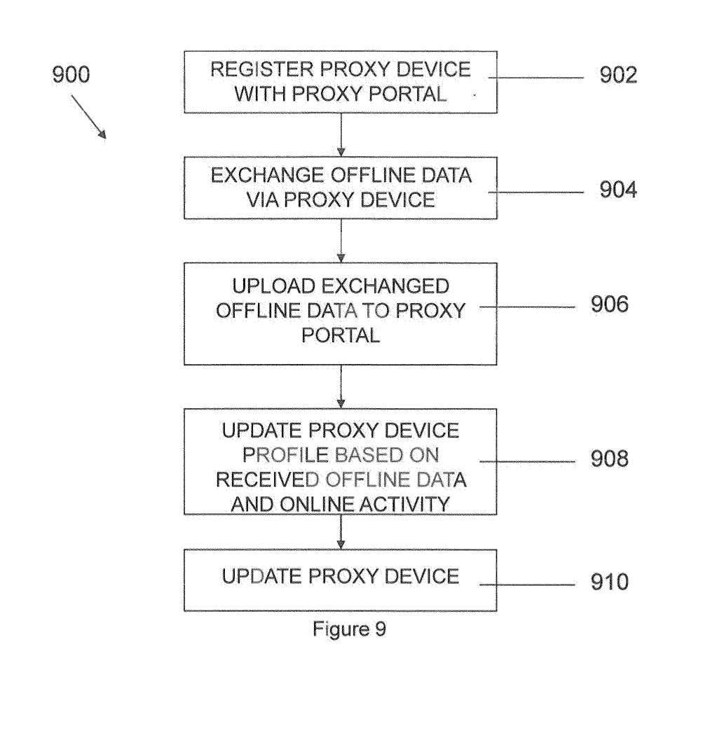

FIG. 9 shows an example flow chart of a process 900 corresponding to the environment of FIG. 1. The process 900 begins when the proxy device is registered with the proxy portal (block 902). In some implementations, the registration process begins upon plugging the proxy device into a computing device through the USB port. The registration process may include using an email account or a social networking account. In some implementations, the email account or social networking account of a parent can be used, but may require pre-authorization from the parent. Upon registering the proxy device, a profile image of the proxy device is provided, selected, established or assigned. Once the password is approved, a dashboard window may appear, in which the profile image in the dashboard is an image of the proxy device being registered. In some implementations, upon registration, the proxy portal may create data structures containing values associated with the proxy device, including a points table, an interactions table, as well as tables including information associated with the user of the proxy device. This information remains secure and not accessible by other users.

Upon registration, the proxy device is ready for use and can exchange offline data (block 904). The proxy device can receive and send offline data by communicating with other proxy devices or equipment associated with people, places and things that are configured to exchange data with the proxy device. In some implementations, the proxy device can communicate using near field communication, RFID or bluetooth technology. The proxy device can connect with other similarly enabled or communication compatible equipment and exchange information, such as profile information associated with the proxy device. In addition, the proxy device can receive identifying information of the equipment with which it has connected as well as location, time and date information. In some implementations, the proxy device can maintain a database of points it has earned and may be configured to transfer points or awards to other proxy devices or equipment. In such implementations, the proxy device may include a processor and memory that can update the points table and can record such transactions.

The proxy device can upload the exchanged offline data to the proxy portal (block 906). The proxy device may connect with the proxy portal wirelessly or through a computing device. Upon establishing a connection, the exchanged offline data is uploaded to the proxy portal. The offline data may include interactions of the proxy device with other equipment and may include additional information including any transfer of points or awards.

The proxy portal can update the proxy device profile based on the received offline information (block 908). In addition, the proxy portal can update the proxy device profile based on any online activity performed through the proxy device's profile. For instance, a message can be sent to the proxy devices with which the proxy device has interacted. Further, points can be transferred or redeemed, and statuses can be changed or updated. Some or all of the activities may allow the proxy device profile to earn points, virtual goods, and skills.

The proxy portal can update the proxy device (block 910). The proxy device can be updated by the proxy portal when the proxy device connects to the proxy portal. In some implementations, the proxy device can be updated by updating the number of points the proxy device has, the number and type of awards the proxy device has, as well as other information associated with the proxy device. In this way, when the proxy device interacts with other proxy devices or NFC enable equipment, the proxy device can provide updated information to the other devices and equipment, while also having an accurate accounting of the number of points and awards. This may be beneficial in implementations where the LED light may be lit at a different color for proxy devices having different number of points.

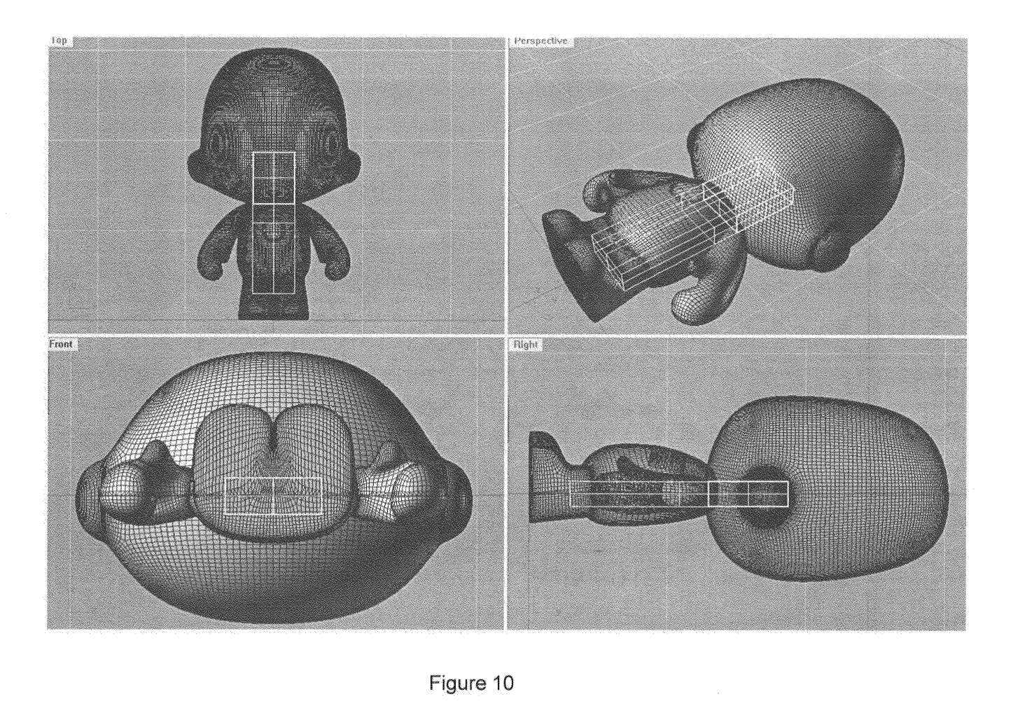

FIG. 10 shows example cross-sectional views of a proxy device including a USB drive and detachable cover portion. As shown, a proxy device can take the shape of a toy in which circuitry may be embedded. In addition, in some implementations, the proxy device may include a USB drive. A portion of the proxy device, such as the head portion of a toy, may be detachable from the toy to expose a USB connector configured to be received by a USB port of a computing device.

The following is an example workflow sequence of an example implementation for connecting the offline world environment with the online world environment using the proxy device. The workflow begins with the authentication of the proxy device by plugging in the example proxy device into the user's computer.
1. Once plugged into a computer through the USB port, a login page pops up on screen (for macs you may have to launch a browser).
2. A child can login using an email and password or login using a parents facebook or foursquare account (must be pre-approved by parents).
3. Once the password is approved, a dashboard or game portal window comes up (the profile image in the dashboard can reflect the same type of Proxy that is inserted in the USB drive.
4. The user has a choice to download the new contacts they have just made.
5. Once approved, the new contacts are imported into the dashboard game portal providing an image, date and time stamp on when the connections were made and with which Proxy. Other details can also be visible including City, State, and Country. Other possible information may include specific location or event where the connection was made. New Proxy contacts also provide skills, tools, and virtual goods that can also be downloaded to use in the online game portal.
6. Once contacts are downloaded, a user can view individual Proxy profiles (profile information can include birth date of Proxy, interests, groups (common groups users may share like soccer, church, etc). Other details include skills, virtual goods acquired, or levels that the associated Proxy has completed in the game world.
7. Users can see a map of the city where a Proxy is from with a limited geo-track component, such as, to the city level, but not to an address or IP address level.
8. If a user wishes, they can send a pre-established message to one of their new Proxy contacts via their “profile” page.
9. Users can move their new Proxy friends into groups which they can select including options like “Soccer Team, School, Band, Etc) They should be able to select from a set of pre-established friend type groups so that they can organize contacts. Users can also create separate groups based on game levels achieved or challenges that users have participated in together.
10. Users should be able to scroll over contacts in their circles or groups (each contact should increase in size when scrolling over it and indicate the date and time where they met).
11. Users should be able to label the event date (a lot like iPhoto) and assign the geographic location where they met (think the new Facebook photo feature).

The following is an example list of features that are provided by a dashboard component of the proxy portal 302:
Users can update their status using pre-approved status icons.
Point tracking—users should be able to see the points they acquired by connecting with their new friends. They should be able to review when they received points for connecting.
The Homepage that includes view of your list of active Proxies (all the Proxies that you own or those that you have launched)—each will have a separate profile “homepage” but they should all be visible on one screen as well.
Tribes (groups of friends connected around common interests, events, and causes) This is the group circle feature that allows kids to organize their friends by how they are connected. They should be able to view each of these friend groups separately if desired.
Trades (list of Proxy trades or point exchanges, profile data captured, etc) This is the portion of the dashboard where they can track the points that they have gained and look at the timeline of who they met and when.
Geo Locator (Map of Proxy Friends—mapping back to the geographic city or town location identified during the profile input) Should show all of their proxy friends across the world with a small Proxy icon.
Active Projects (ability to view and place points in active non-profit projects—clean water, school supplies, mosquito nets, etc) Users should be able to allocate their points into these projects. Each project module will provide an aggregated update on how many points have been collected for each and what they have accomplished (almost like a living social resume for the child).
Brand Sponsors—see a list of brand sponsors and check-in locations (just like foursquare) This will be along the bottom of the dashboard and act much like a ticker. Users should be able to actively see a module that allows them to know where points or virtual items are being offered, the approximate distance, and how many points are available for checking into this location.
Challenges—This part allows kids to see the most current challenges posted. A challenge might include a Starbucks sponsored “clean up the park day” that incentivies kids to come out and win an eco-badge and Proxy Points. Or, this could include a visit to Chicago's bean to protect the portals. These are location-based or home-based challenges that kids can participate in that teach social responsibility and allow an incentive for Point awards from brands, educators, or parents.
Treasure Hunt Feature—shows point values on a map based on geographic location where kids can uncover badges, tools, skills or points that will help them build or purchase things in their virtual Proxy world.
Distance to Proxy Points (like the Portland Cocktail Compass App)
News Feeds—kids will be permitted to “subscribe” to current non-profit or culture news feeds about fun games, music, education, and culture

The following is an example list of options that may be used to build a profile of a proxy device:
Boy or Girl
Favorite Movie
Favorite Type of Music
Favorite TV Show
Favorite Band
Favorite Activities
Favorite Sport
Favorite Color
Favorite Movie
Favorite Food
Favorite Charity
Favorite Place to Visit
Favorite Book
Favorite Game
Favorite Sports Team
Favorite Athlete
What you want to be: (drop down list provided)

The following is an example list of characters that a user may choose from to be their proxy device:
Proxy Boy
Robot
Emo
Rocker
Skater
Alien
Princess
Kitten
Proxy Girl
Dog/Puppy
Monkey
Ninja
Penguin
Seal/Sea Lion
Domo Type Doll

In some implementations, the proxy portal can handle proxy points as follows:

### Point Acquisition:

Points, skills, and virtual goods are acquired by meeting another Proxy (exchanging profile data or by interacting with an NFC tag—for NFC enabled devices)
A mechanism to collect points virtually by checking into a location and with a geo-location component for the mobile application (allowing others to see what other Proxies may be nearby)
Points can be gained through individual or group challenges.
Challenges can be set up by parents, educators, brands, or other kids.
Points can be redeemable for tangible items for non-profits as well as virtual goods for a proxy device.

### Point Redemption:

Can include point redemption model that allows users to assign aggregated points to a charity of their choice (select from a list of charities and assign points)
Points can be used to purchase items through the Proxy Portal (both tangible items that support a charity as well as virtual goods).

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine-readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed:

1. A system comprising:
a mobile proxy device that is configured to connect with other proxy devices associated with people, places or things;
an online world environment;
wherein the mobile proxy device has an online identity created by a user;
wherein the mobile proxy device tracks interactions with other proxy devices in an offline environment;
wherein the mobile proxy device is configured to connect to the online world environment and communicate the tracked interactions from the offline environment; and
wherein the online world environment is configured to allow the user to interact with the tracked interactions from the offline environment via the online identify in the online world environment.
